(19) United States
(12) Patent Application Publication
(10) Pub. No.: US 2026/0318367 A1
(43) Pub. Date: Oct. 15, 2026

(54) VEHICLE DRIVELINE COMPONENT HAVING FRICTION CLUTCH

(71) Applicant: BorgWarner Inc., Auburn Hills, MI (US)

(72) Inventors: Lee Bolton, Seneca, SC (US); Matt Harmon, Westminster, SC (US); Megan Kavanaugh, Sterling Heights, MI (US)

(21) Appl. No.: 19/116,525

(22) PCT Filed: Oct. 4, 2023
(86) PCT No.: PCT/US2023/034420

§ 371 Date: Mar. 28, 2025

Related U.S. Application Data
(60) Provisional application No. 63/413,374, filed on Oct. 5, 2022.

(51) Int. Cl. F16D 13/70; B60K 17/02; B60K 17/28; B60K 17/344; F16D 13/52

(52) U.S. Cl. CPC F16D 13/70; F16D 13/52; B60K 17/02; B60K 17/28; B60K 17/344; F16D 2200/0021; F16D 2250/0084

(57) ABSTRACT

A vehicle driveline component with a friction clutch having a clutch hub, a clutch drum, a clutch pack and a pressure plate. The clutch pack has a plurality of first clutch plates, which are axially slidably but non-rotatably coupled to the clutch hub, and a plurality of second clutch plates that are interleaved with the first clutch plates and axially slidably but non-rotatably coupled to the clutch drum. The pressure plate is non-rotatably but axially slidably engaged to one of the clutch hub and the clutch drum and is movable along a rotational axis of the one of the clutch hub and the clutch drum to compress the clutch pack. The pressure plate has a hub portion and a flange that extends radially outwardly from the hub portion. A plurality of apertures are formed in the flange.

### CROSS-REFERENCE TO RELATED APPLICATIONS

The present application claims the benefit of U.S. Application No. 63/413,374 filed Oct. 5, 2022, the disclosure of which is incorporated by reference as if fully set forth in detail herein.

### FIELD

The present disclosure relates to a vehicle driveline component having a friction clutch.

### BACKGROUND

This section provides background information related to the present disclosure which is not necessarily prior art.

Friction clutches are commonly employed in various vehicle driveline components, such as transfer cases, electric drive units, power take-off units, torque transfer couplings, and axle assemblies to selectively transfer rotary power between two components of the vehicle driveline component. Such friction clutches commonly include a clutch hub, a clutch drum, a clutch pack and a pressure plate. The clutch pack includes first clutch plates, which are axially slidably but non-rotatably coupled to the clutch hub, and a plurality of second clutch plates that are interleaved with the first clutch plates and axially slidably but non-rotatably coupled to the clutch drum. Each of the first clutch plates and/or each of the second clutch plates can include an annular steel plate and a friction material that is adhered to the annular steel plate. The pressure plate can be axially slidably but non-rotatably coupled to either the clutch hub or the clutch drum and can be translated along the rotational axis of the friction clutch to selectively compress the clutch pack to permit torque transmission between the first and second clutch plates.

It is relatively common to specify a torque curve for a friction clutch that is used in a vehicle driveline component. In brief, the torque curve associates the position of the pressure plate (relative to a kiss point) with the amount of torque that the friction clutch is able to transmit. When a friction clutch is designed to perform within acceptable limits of a predetermined torque curve, the friction clutch can be integrated into the vehicle driveline component without a need for empirically determining the actual torque curve of the friction clutch and thereafter calibrating the controller that operates the actuator of the friction clutch to compensate for differences between the actual torque curve and the design target torque curve.

Heretofore, it has been a significant challenge to design a relatively low-cost friction clutch that is robust, easily manufactured, and has an actual torque curve that matches the design target torque curve. With reference to FIG. 1, an exemplary prior art friction clutch 2 is illustrated in cross-section and under a predetermined load. Bending of various components within the friction clutch 2, including a conventional pressure plate 4, can cause some of the clutch plates 6a, 6b in the friction clutch 2 to bind rather than slide in an axial direction. When such binding occurs, the clutch plates 6a, 6b that experience binding transmit relatively less torque than the clutch plates 6a, 6b that do not experience binding so that the actual torque curve of the friction clutch 2 deviates from the design target torque curve. This situation cannot be rectified by merely exerting more force onto the clutch plates 6a, 6b as this would tend to overload the clutch plates 6a, 6b that are not experiencing binding and more significantly, does not change the actual torque curve of the friction clutch 2 so that it would match the design target torque curve.

One proposed solution adds clutch plates 6a, 6b into the friction clutch 2. Unfortunately, the addition of clutch plates 6a, 6b to the friction clutch 2 increases the cost of the friction clutch 2 as well as the physical size of the friction clutch 2.

Consequently, there remains a need in the art for an improved friction clutch whose actual torque curve is easily modifiable to conform to a design target torque curve.

### SUMMARY

This section provides a general summary of the disclosure and is not a comprehensive disclosure of its full scope or all of its features.

In one form, the present disclosure provides a vehicle driveline component that includes a friction clutch. The friction clutch has a clutch hub, a clutch drum, a clutch pack and a pressure plate. The clutch hub defines a plurality of first spline teeth while the clutch drum defines a plurality of second spline teeth. The clutch pack has a plurality of first clutch plates and a plurality of second clutch plates. The first clutch plates engage the first spline teeth to axially slidably but non-rotatably couple the first clutch plates to the clutch hub. The second clutch plates are interleaved with the first clutch plates and engage the second spline teeth to axially slidably but non-rotatably couple the second clutch plates to the clutch drum. The pressure plate is non-rotatably but axially slidably engaged to one of the clutch hub and the clutch drum. The pressure plate has a hub portion and a flange that extends radially outwardly from the hub portion. The pressure plate is movable along a rotational axis of the one of the clutch hub and the clutch drum to compress the clutch pack to frictionally engage the first and second clutch plates to one another. A plurality of apertures are formed in the flange.

In another form, the present disclosure provides a method for forming a friction clutch. The method includes: developing a first friction clutch having a clutch hub, a clutch drum, a clutch pack and a first pressure plate, the clutch hub defining a plurality of first spline teeth, the clutch drum defining a plurality of second spline teeth, the clutch pack having a plurality of first clutch plates and a plurality of second clutch plates, the first clutch plates engaging the first spline teeth to axially slidably but non-rotatably couple the first clutch plates to the clutch hub, the second clutch plates being interleaved with the first clutch plates and engaging the second spline teeth to axially slidably but non-rotatably couple the second clutch plates to the clutch drum, the first pressure plate being non-rotatably but axially slidably engaged to one of the clutch hub and the clutch drum, the first pressure plate having a first hub portion and a first flange that extends radially outwardly from the first hub portion, the first flange having a first geometric configuration that provides the first flange with a first stiffness, the pressure plate being movable along a rotational axis of the one of the clutch hub and the clutch drum to compress the clutch pack to thereby frictionally engage the first and second clutch plates; obtaining a torque curve of the first friction clutch; developing a second pressure plate having a second hub portion and a second flange, the second flange having a second geometric configuration that is different from the first geometric configuration and that includes a plurality of apertures, wherein the second geometric configuration provides the second flange of the second pressure plate with a second stiffness that is different from the first stiffness; and providing a second friction clutch having the clutch hub, the clutch drum, the clutch pack and the second pressure plate, wherein a torque curve of the second friction clutch conforms to a predetermined torque curve within predetermined limits.

In still another form, the present disclosure provides a vehicle driveline component with a friction clutch with a clutch hub, a clutch drum, a clutch pack and a pressure plate. The clutch hub defines a plurality of first spline teeth, while the clutch drum defines a plurality of second spline teeth. The clutch pack has a plurality of first clutch plates and a plurality of second clutch plates. The first clutch plates engage the first spline teeth to axially slidably but non-rotatably couple the first clutch plates to the clutch hub. The second clutch plates are interleaved with the first clutch plates and engage the second spline teeth to axially slidably but non-rotatably couple the second clutch plates to the clutch drum. The pressure plate is non-rotatably but axially slidably engaged to one of the clutch hub and the clutch drum. The pressure plate has a hub portion and a flange that extends radially outwardly from the hub portion. The flange defines a flange body and a raised land. The flange body extends radially outwardly from the hub portion of the pressure plate. The raised land extends in a circumferential direction and has an engagement surface that is offset from the flange body along a rotational axis of the one of the clutch hub and the clutch drum. The engagement surface of the raised land directly engages a friction material on one of the first and second clutch plates when the pressure plate is moved along the rotational axis to compress the clutch pack. At least one stiffness-modifying feature is incorporated into the flange. The stress-modifying feature creates a discontinuity in the engagement surface.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a section view of a prior art friction clutch with a predetermined load being applied through a conventional pressure plate to a clutch pack;

FIG. 2 is a perspective view of an exemplary vehicle driveline component having a friction clutch that is constructed in accordance with the teachings of the present disclosure;

FIG. 3 is a section view taken through the vehicle driveline component of FIG. 2;

FIG. 4 is an enlarged portion of FIG. 3;

FIGS. 5 and 6 are perspective views of a portion of the vehicle driveline component of FIG. 2 illustrating a pressure plate of a friction clutch;

FIG. 7 is a front plan view of the pressure plate;

FIG. 8 is a section view of the pressure plate;

FIG. 9 is a perspective section view of the pressure plate;

FIG. 10 is a section view of a portion of the vehicle driveline component of FIG. 2 illustrating the friction clutch with a predetermined load being applied through the pressure plate to a clutch pack; and

FIG. 11 is a plot depicting a target torque curve, a torque curve for the friction clutch of FIG. 1, and a torque curve for the friction clutch of the vehicle driveline component of FIG. 2.

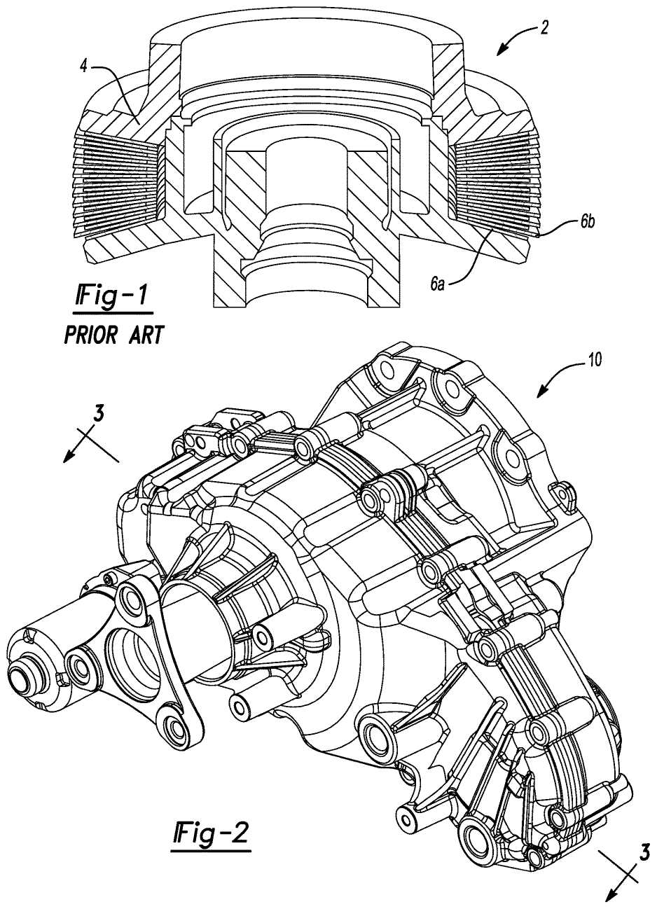

Corresponding reference numerals indicate corresponding parts throughout the several views of the drawings.

### DETAILED DESCRIPTION

With reference to FIG. 2, an exemplary vehicle driveline component constructed in accordance with the teachings of the present disclosure is generally indicated by reference numeral 10. The vehicle driveline component 10 is illustrated to be a transfer case of the type that is selectively operable in a 2-wheel drive mode and a 4-wheel drive mode. It will be appreciated, however, that the teachings of the present disclosure have application to various other types of driveline components, including power take-off units, axle assemblies, electro-hydraulic clutches (e.g., a Haldex® coupling manufactured by BorgWarner Inc. of Auburn Hills, Michigan) and electric drive units.

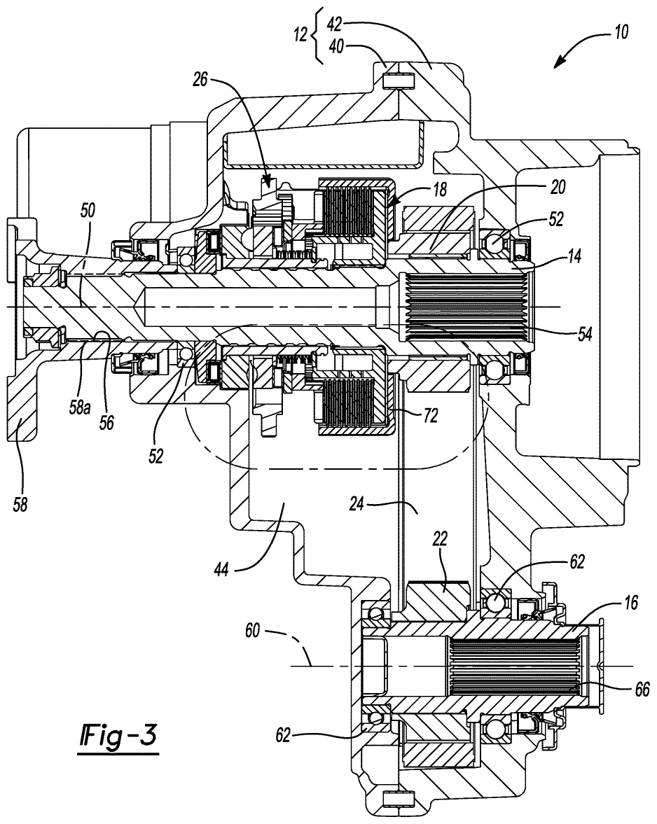

With reference to FIG. 3, the vehicle driveline component 10 can include a housing 12, a first shaft 14, a second shaft 16, a friction clutch 18, a drive element 20, a driven element 22, an endless power transmitting component 24, and a clutch actuator 26. The housing 12 can comprises first and second housing halves 40 and 42, respectively, that can be fastened together to define an internal cavity 44 into which the first and second shafts 14 and 16, the friction clutch 18, the drive and driven elements 20 and 22, the endless power transmitting component 24, and the clutch actuator 26 can be received.

The first shaft 14 can be supported for rotation about a first axis 50 relative to the housing 12 by a pair of first bearings 52. In the example provided, the first shaft 14 has female splined input end 54 and a male splined output end 56. The input end 54 is configured to receive and mating engage a male splined end (not shown) of power and drive train (not shown) that provides a source of rotary power. The output end 56 can be matingly engaged to a female splined aperture 58a in an output flange 58 that can be coupled to a propshaft (not shown) in a conventional manner. The propshaft can conventionally transmit rotary power to a rear axle assembly (not shown).

The second shaft 16 can be supported for rotation about a second axis 60 relative to the housing 12 by a pair of second bearings 62. The second axis 60 can be parallel to the first axis 50. The second shaft 16 can have a female splined output end 66 that can be configured to engage a male splined end (not shown) of a shaft (not shown) that transmits rotary power to a front axle assembly (not shown).

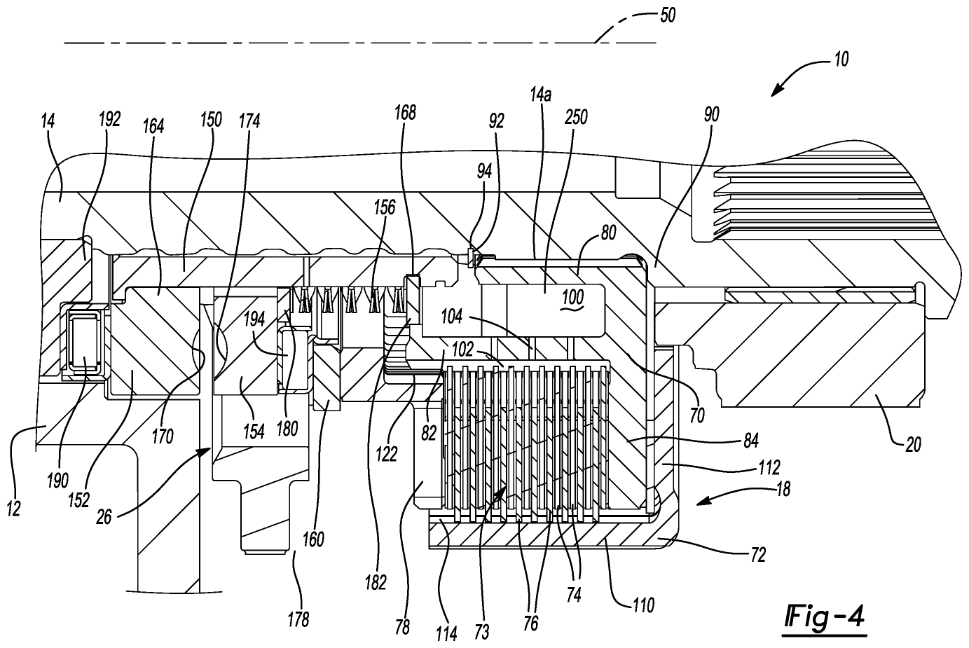

With reference to FIG. 4, the friction clutch 18 can include a clutch hub 70, a clutch drum 72, a clutch pack 73, which has a plurality of first clutch plates 74 and a plurality of second clutch plates 76, and a pressure plate 78. The clutch hub 70 can have a hub portion 80, a first plate mount 82 and a radial wall 84. The hub portion 80 can be non-rotatably coupled to the first shaft 14 in any desired manner. In the example shown, the hub portion 80 defines a female splined aperture that is received on a male splined segment 14a of the first shaft 14. The clutch hub 70 can be abutted against a shoulder 90 on the first shaft 14 and an external snap ring 92, which is received in a ring groove 94 formed in the first shaft 14, can be employed to inhibit or limit movement of the clutch hub 70 along the first axis 50 in a direction away from the shoulder 90. The radial wall 84 can have an annular shape and can be fixedly coupled to and extend radially outwardly from the hub portion 80. The first plate mount 82 can be fixedly coupled to and extend axially from the radial wall 84. The first plate mount 82 can be an annular structure that can be spaced radially outwardly from and concentrically about the clutch hub 70 such that an annular lubricant chamber 100 is disposed radially outwardly of the hub portion 80. The first plate mount 82 can have a radially outer surface with a plurality of spline teeth 102 formed thereon and a plurality of clutch plate lubricant passages 104 can be formed radially through the first plate mount 82 to permit lubricant to flow through the first plate mount 82 into the annular lubricant chamber 100.

The clutch drum 72 can be a drum-like structure having a second plate mount 110 and an annular wall member 112. The second plate mount 110 can be a circumferentially extending wall that is disposed concentrically about the first plate mount 82. The second plate mount 110 can have an inner circumferential surface, which can have a plurality of spline teeth 114 formed thereon. The annular wall member 112 can extend radially inwardly from the second plate mount 110.

The first clutch plates 74 can be axially slidably but non-rotatably coupled to the first plate mount 82. In the example provided, the first clutch plates 74 conventionally have an aperture that defines a plurality of spline teeth (not specifically shown) and the first plate mount 82 is received into the aperture such that the spline teeth 102 of the first plate mount 82 meshingly engage the spline teeth of the first clutch plates 74.

The second clutch plates 76 can be interleaved with the first clutch plates 74 and can be axially slidably but non-rotatably coupled to the second plate mount 110. In the example provided, the second clutch plates 76 conventionally have an outer diametrical surface that defines a plurality of spline teeth (not specifically shown) and the second clutch plates 76 are received into the second plate mount 110 such that the spline teeth of the second clutch plates 76 meshingly engage the spline teeth 114 of the second plate mount 110.

The pressure plate 78 can be non-rotatably but axially slidably coupled to one of the clutch hub 70 and the clutch drum 72 and can be movable along the first axis 50 to selectively apply a compressive force to the clutch pack 73, which causes frictional engagement between the first and second clutch plates 74 and 76. In the example provided, the pressure plate 78 is disposed on a side of the clutch pack 73 that is opposite the radial wall 84 of the clutch hub 70 and the pressure plate 78 is axially slidably but non-rotatably coupled to the first plate mount 82. The pressure plate 78 can have an aperture that defines a plurality of spline teeth 122 and which receives the first plate mount 82 such that the spline teeth 102 of the first plate mount 82 meshingly engage the spline teeth 122 of the pressure plate 78.

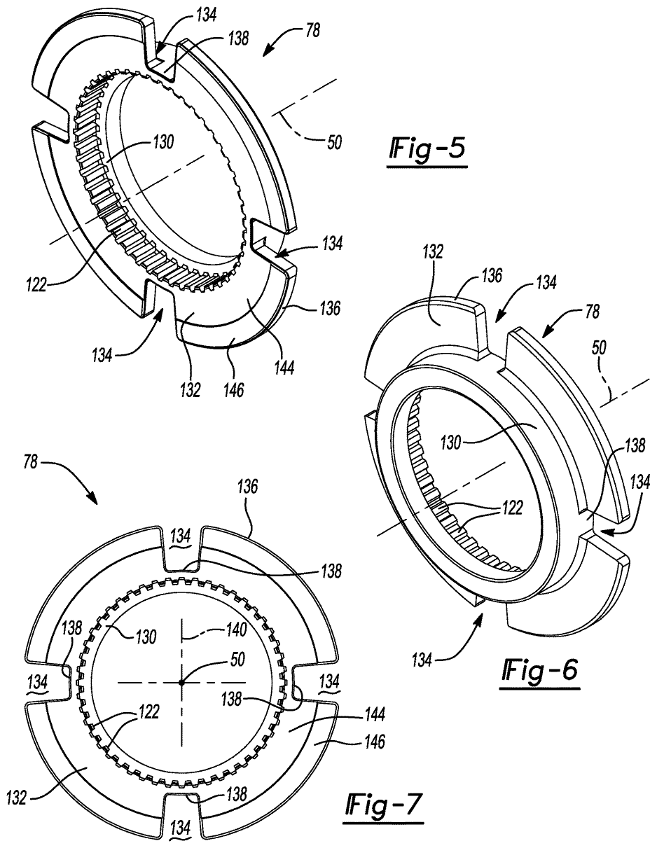

With reference to FIGS. 5 and 6, the pressure plate 78 has a hub portion 130 and a flange 132 that extends radially outwardly from the hub portion 130. A plurality of apertures 134 are formed in the flange 132. The apertures 134 are sized, shaped and located to tailor the ability of the pressure plate to load the clutch pack 73. In the example shown, the apertures 134 are disposed circumferentially apart from one another symmetrically about the first axis 50, the apertures 134 extend along the first axis 50 fully through the flange 132, and the apertures 134 extend in a radial direction through the outer circumferential surface 136 of the flange 132 of the pressure plate 78. However, the apertures 134 need not be symmetrically spaced about the flange 132, need not be formed to extend fully through the flange 132 in an axial direction (i.e., along the first axis 50), and need not extend radially through the outer circumferential surface 136 of the flange 132. The pressure plate 78 can be formed in any desired manner, for example via compacting and sintering a powdered metal material.

With reference to FIG. 7, each of the apertures 134 can have a radially inner edge 138 that can optionally be defined by a circular segment. Also optionally, the circular segments that define the radially inner edges 138 of the apertures 134 can be concentric with the outer circumferential surface 136 of the flange 132. Each of the apertures 134 can have a central axis 140 about which the aperture 134 is symmetric and the central axis 140 of each aperture 134 can extend in a radial direction relative to the first axis 50. In the example provided, the central axis 140 of each aperture 134 intersects the first axis 50, but it will be appreciated that the central axes 140 of the apertures 134 could be skewed to the first axis 50.

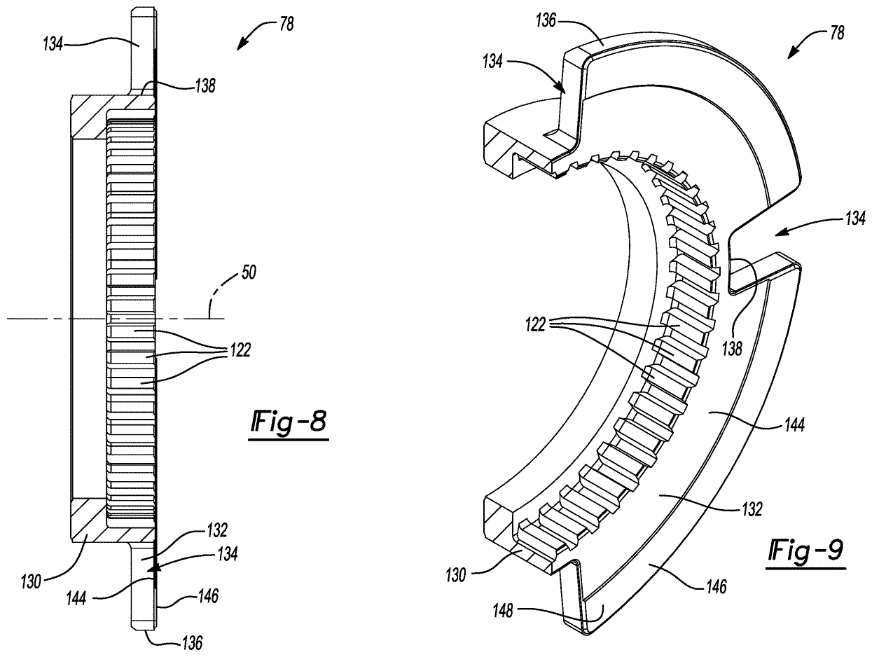

With reference to FIGS. 8 and 9, the flange 132 can define a flange body 144 and a raised land 146 The flange body 144 can extend radially outwardly from the hub portion 130 of the pressure plate 78. The raised land 146 can extend in a circumferential direction and can have an engagement surface 148 that is offset from the flange body 144 along the first axis 50. The engagement surface 148 of the raised land 146 is configured to directly engage the clutch pack 73 (FIG. 4) when the pressure plate 78 is moved along the first axis 50 to compress the clutch pack 73 (FIG. 4). Optionally, some or all of the apertures 134 can intersect the raised land 146. In the example shown, the apertures 134 are formed through the raised land 146 so that the engagement surface 148 is discontinuous in a circumferential direction.

Returning to FIG. 3, the drive element 20 can be coupled to the clutch drum 72 for common or joint rotation, the driven element 22 can be coupled to the second shaft 16 for common or joint rotation, and the endless power transmitting component 24 is configured to transmit rotary power between the drive element 20 and the driven element 22. In the example provided, the drive and driven elements 20 and 22 are sprockets and the endless power transmitting component is a loop of chain. It will be appreciated, however, that the drive and driven elements 20 and 22 could be pulleys and the endless power transmitting component 24 could be a belt.

With renewed reference to FIG. 4, the clutch actuator 26 can be any type of actuator that can selectively move the pressure plate 78 along the first axis 50 and develop/exert force (through the pressure plate 78) along the first axis 50 to cause frictional engagement between the first and second clutch plates 74 and 76 so that rotary power is transmitted between the clutch hub 70 and the clutch drum 72. In the example provided, the clutch actuator is a ball-ramp actuator and comprises a clutch sleeve 150, a first ball-ramp cam 152, a second ball-ramp cam 154, a biasing spring 156, a plurality of spherical balls (not shown) received between the first and second ball-ramp cams 152 and 154, and an actuator output member 160. The clutch sleeve 150 can be a tubular structure that can be received on the first shaft 14. The clutch sleeve 150 can define a shoulder 164, which can be located proximate a first axial end of the clutch sleeve 150, and a retaining ring groove 168.

The first ball-ramp cam 152 can be fixedly coupled to the housing 12 and can define a plurality of first ball-ramp grooves 170 that are formed into an axial end face of the first ball-ramp cam 152. The first ball-ramp grooves 170 extend in a circumferential direction and the depth of each of the first ball-ramp grooves 170 varies (i.e., tapers) between its opposite ends. The first ball-ramp cam 152 can be fixedly coupled to the clutch sleeve 150 and can be abutted against the shoulder 164. In the example provided, the first ball-ramp cam 152 is press-fit to the clutch sleeve 150, but it will be appreciated that any means, including fasteners and/or splines can be employed to fixedly and/or non-rotatably couple the first ball-ramp cam 152 to the clutch sleeve 150.

The second ball-ramp cam 154 can be received over the clutch sleeve 150 and can define a plurality of second ball-ramp grooves 174 that are formed into an axial end face of the second ball-ramp cam 154. The second ball-ramp grooves 174 extend in a circumferential direction and the depth of each of the second ball-ramp grooves 174 varies (i.e., tapers) between its opposite ends in a manner that is opposite the manner in which each of the first ball-ramp grooves 170 varies (i.e., tapers) between its opposite ends. The second ball-ramp cam 154 is rotatable about the first axis 50 between a first cam position and second cam position. The second ball-ramp cam 154 is also axially movable along the first axis 50 relative to the first ball-ramp cam 152. In the example provided, a gear 178 is employed to rotate the second ball-ramp cam 154 about the first axis 50. The second ball-ramp cam 154 is mounted to the gear 178 concentrically within the gear 178.

The biasing spring 156 can comprise one or more springs that can bias the second ball-ramp cam 154 along the first axis 50 toward the first ball-ramp cam 152. In the example provided, the biasing spring 156 comprises a wave spring that is disposed between a thrust washer 180, which is slidably received on the clutch sleeve 150 and abuts the second ball-ramp cam 154 on a side opposite the first ball-ramp cam 152, and an external snap ring 182 that is received in the retaining ring groove 168 formed in the clutch sleeve 150.

The spherical balls are received between the first and second ball-ramp cams 152 and 154 and each of the spherical balls is received in an associated one of the first ball-ramp grooves 170 and an associated one of the second ball-ramp grooves 174. Rotation of the second ball-ramp cam 154 (via the gear 178) from its first cam position to its second cam position conventionally causes the spherical balls to roll between the first and second ball-ramp cams 152 and 154 into shallower regions of the first and second ball-ramp grooves 170 and 174, which overcomes the biasing force of the biasing spring 156 and causes the second ball-ramp cam 154 to translate along the first axis 50 in a direction away from the first ball-ramp cam 152. Similarly, rotation of the second ball-ramp cam 154 (via the gear 178) from its second cam position to its first cam position conventionally causes the spherical balls to roll between the first and second ball-ramp cams 152 and 154 into deeper regions of the first and second ball-ramp grooves 170 and 174, which permits the biasing spring 156 to urge the second ball-ramp cam 154 along the first axis 50 in a direction toward the first ball-ramp cam 152.

In the example provided, a first thrust bearing 190 is disposed between the first ball-ramp cam 152 and a flange 192 that is fixedly coupled to the first shaft 14, a second thrust bearing 194 is disposed between the second ball-ramp cam 154 and the actuator output member 160. In this example, the actuator output member 160 is an apply plate that is configured to transmit force between the second ball-ramp cam 154 and the pressure plate 78. While the actuator output member 160 is shown in the accompanying drawings as being a discrete component, it will be appreciated that the actuator output member 160 could be fixedly coupled to (e.g., unitarily and integrally formed with) the pressure plate 78.

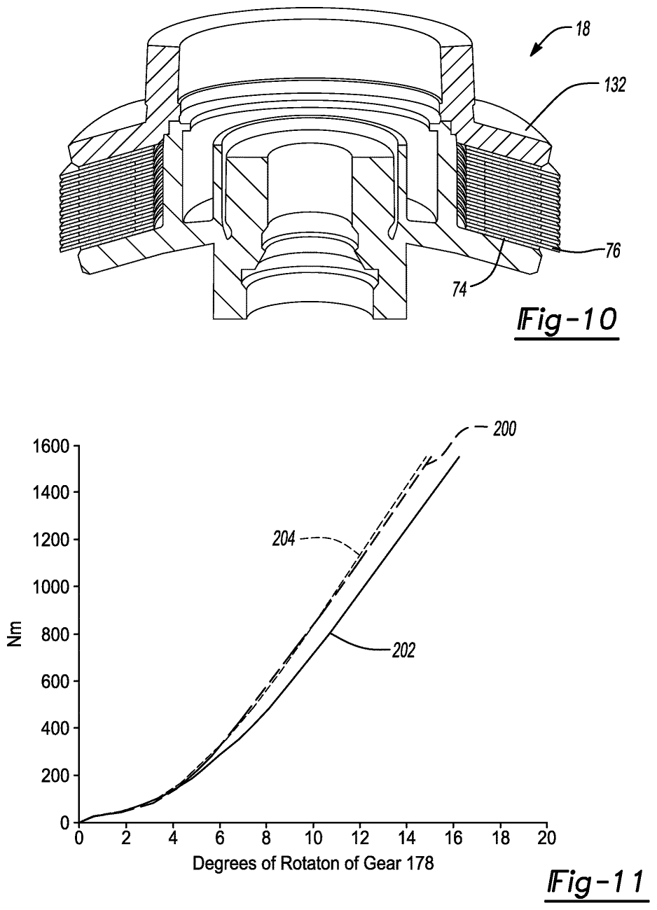

With reference to FIGS. 9 and 10, the apertures 134 in the flange 132 are configured (i.e., through their quantity, as well as their size, shape and position) to prevent binding of the first and second clutch plates 74 and 76 and to ensure load is transmitted through the friction clutch 18 in a consistent manner throughout the operational range of the friction clutch 18. In this regard, the apertures 134 in the flange 132 provide controlled flexing of the pressure plate 78. The controlled flexing provided by the apertures 134 has the further benefit of reducing the amplitude of torque oscillations that would otherwise be transmitted through the friction clutch 18 when the load that is exerted onto the friction clutch 18 changes.

Significantly, the configuration of the apertures 134 can changed as needed to change the actual torque curve of the friction clutch 18. In FIG. 11, reference numeral 200 indicates a desired target torque curve for a friction clutch, reference numeral 202 indicates the actual torque curve for a friction clutch that is identical to the friction clutch 18 (FIG. 4) except that no apertures are formed in the flange of the pressure plate (i.e., a conventional pressure plate) is employed, and reference numeral 204 indicates the actual torque curve for the friction clutch 18 (FIG. 4).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle driveline component comprising:
a friction clutch having a clutch hub, a clutch drum, a clutch pack and a pressure plate, the clutch hub defining a plurality of first spline teeth, the clutch drum defining a plurality of second spline teeth, the clutch pack having a plurality of first clutch plates and a plurality of second clutch plates, the first clutch plates engaging the first spline teeth to axially slidably but non-rotatably couple the first clutch plates to the clutch hub, the second clutch plates being interleaved with the first clutch plates and engaging the second spline teeth to axially slidably but non-rotatably couple the second clutch plates to the clutch drum, the pressure plate being non-rotatably but axially slidably engaged to one of the clutch hub and the clutch drum, the pressure plate having a hub portion and a flange that extends radially outwardly from the hub portion, the pressure plate being movable along a rotational axis of the one of the clutch hub and the clutch drum to compress the clutch pack to thereby frictionally engage the first and second clutch plates, wherein a plurality of apertures are formed in the flange.

2. The vehicle driveline component of claim 1, wherein the pressure plate is formed of a sintered, compacted, powdered metal material.

3. The vehicle driveline component of claim 1, wherein the flange of the pressure plate has an outer circumferential surface, and wherein the apertures extend through the outer circumferential surface.

4. The vehicle driveline component of claim 1, wherein the apertures are spaced symmetrically apart about the rotational axis.

5. The vehicle driveline component of claim 1, wherein each of the apertures has a radially inner edge that is defined by a circular segment.

6. The vehicle driveline component of claim 5, wherein the circular segments are concentric with an outer circumferential surface of the flange.

7. The vehicle driveline component of claim 1, wherein each of the apertures has a central axis about which the aperture is symmetric, the central axis extending in a radial direction relative to the rotational axis.

8. The vehicle driveline component of claim 1, wherein the flange defines a flange body and a raised land, the flange body extending radially outwardly from the hub portion of the pressure plate, the raised land extending in a circumferential direction and having an engagement surface that is offset from the flange body along the rotational axis of the one of the clutch hub and the clutch drum, the engagement surface of the raised land directly engaging the clutch pack when the pressure plate is moved along the rotational axis to compress the clutch pack.

9. The vehicle driveline component of claim 8, wherein the apertures intersect the raised land.

10. The vehicle driveline component of claim 9, wherein the apertures are formed through the raised land so that the engagement surface is discontinuous in a circumferential direction.

11. The vehicle driveline component of claim 1, wherein the apertures extend along the rotational axis of the one of the clutch hub and the clutch drum through the flange.

12. The vehicle driveline component of claim 1, further comprising:
a housing;
an input shaft that is rotatably disposed in the housing; and
an output shaft;
wherein the friction clutch is disposed in a power transmission path that extends between the input shaft and the output shaft.

13. The vehicle driveline component of claim 12, wherein the vehicle driveline component is selected from a group consisting of: transfer cases, electric drive units, power take-off units, torque transfer couplings, and axle assemblies.

14. A method for forming a friction clutch, the method comprising:
developing a first friction clutch having a clutch hub, a clutch drum, a clutch pack and a first pressure plate, the clutch hub defining a plurality of first spline teeth, the clutch drum defining a plurality of second spline teeth, the clutch pack having a plurality of first clutch plates and a plurality of second clutch plates, the first clutch plates engaging the first spline teeth to axially slidably but non-rotatably couple the first clutch plates to the clutch hub, the second clutch plates being interleaved with the first clutch plates and engaging the second spline teeth to axially slidably but non-rotatably couple the second clutch plates to the clutch drum, the first pressure plate being non-rotatably but axially slidably engaged to one of the clutch hub and the clutch drum, the first pressure plate having a first hub portion and a first flange that extends radially outwardly from the first hub portion, the first flange having a first geometric configuration that provides the first flange with a first stiffness, the pressure plate being movable along a rotational axis of the one of the clutch hub and the clutch drum to compress the clutch pack to thereby frictionally engage the first and second clutch plates;
obtaining a torque curve of the first friction clutch;
developing a second pressure plate having a second hub portion and a second flange, the second flange having a second geometric configuration that is different from the first geometric configuration and that includes a plurality of apertures, wherein the second geometric configuration provides the second flange of the second pressure plate with a second stiffness that is different from the first stiffness; and
providing a second friction clutch having the clutch hub, the clutch drum, the clutch pack and the second pressure plate, wherein a torque curve of the second friction clutch conforms to a predetermined torque curve within predetermined limits.

15. The method of claim 14, wherein the second flange defines a flange body and a raised land, the flange body extending radially outwardly from the hub portion of the second pressure plate, the raised land extending in a circumferential direction and having an engagement surface that is offset from the flange body along the rotational axis of the one of the clutch hub and the clutch drum, the engagement surface of the raised land directly engaging a friction material on one of the first and second clutch plates when the second pressure plate is moved along the rotational axis to compress the clutch pack.

16. The method of claim 15, wherein the apertures intersect the raised land.

17. The method of claim 16, wherein the apertures are formed through the raised land so that the engagement surface is discontinuous in a circumferential direction.

18. The method of claim 14, wherein the apertures extend through the second flange along the rotational axis of the one of the clutch hub and the clutch drum.

19. The method of claim 14, wherein the second pressure plate is formed of a sintered, compacted, powdered metal material.

20. The method of claim 14, wherein the second flange of the second pressure plate has an outer circumferential surface, and wherein the apertures extend through the outer circumferential surface.

21. A vehicle driveline component comprising:
a friction clutch having a clutch hub, a clutch drum, a clutch pack and a pressure plate, the clutch hub defining a plurality of first spline teeth, the clutch drum defining a plurality of second spline teeth, the clutch pack having a plurality of first clutch plates and a plurality of second clutch plates, the first clutch plates engaging the first spline teeth to axially slidably but non-rotatably couple the first clutch plates to the clutch hub, the second clutch plates being interleaved with the first clutch plates and engaging the second spline teeth to axially slidably but non-rotatably couple the second clutch plates to the clutch drum, the pressure plate being non-rotatably but axially slidably engaged to one of the clutch hub and the clutch drum, the pressure plate having a hub portion and a flange that extends radially outwardly from the hub portion, wherein the flange defines a flange body and a raised land, the flange body extending radially outwardly from the hub portion of the pressure plate, the raised land extending in a circumferential direction and having an engagement surface that is offset from the flange body along a rotational axis of the one of the clutch hub and the clutch drum, the engagement surface of the raised land directly engaging a friction material on one of the first and second clutch plates when the pressure plate is moved along the rotational axis to compress the clutch pack;
wherein at least one stiffness-modifying feature is incorporated into the flange, the stress-modifying feature creating a discontinuity in the engagement surface.

22. The vehicle driveline component of claim 21, wherein the at least one stiffness-modifying feature comprises a plurality of apertures.

23. The vehicle driveline component of claim 22, wherein the apertures are formed through the flange in a direction along the rotational axis.

24. The vehicle driveline component of claim 22, wherein the apertures intersect a radially outer edge of the flange.
